(19) United States
(12) Patent Application Publication
(10) Pub. No.: US 2017/0249673 A1
(43) Pub. Date: Aug. 31, 2017

(54) Out-of-home and/or home targeted interactive content, infomercial and advertising

(71) Applicant: Gary Vildaver, Rego Park, NY (US)

(72) Inventor: Gary Vildaver, Rego Park, NY (US)

(21) Appl. No.: 15/291,811

(22) Filed: Oct. 12, 2016

Related U.S. Application Data
(60) Provisional application No. 62/389,409, filed on Feb. 26, 2016.

(51) Int. Cl. G06Q 30/02; G06F 3/14

(52) U.S. Cl. CPC G06Q 30/0275; G06F 3/14; H04L 67/306

(57) ABSTRACT

Methods, systems, and apparatus, including computer program products, for Out-of-home and/or home targeted interactive content, infomercial and advertizing is based on generating and/or receiving user identifier/s for each individual person from the audience, viewers and/or users (“User”) in the vicinity of out-of-home electronic or not displays such as prints, banners and/or video billboards of any kind and/or home entertainment such as computer monitors, computers connected to TV sets, smart TVs and/or TV sets stationary or moving (“Display”). User identifier is generated based on retrieved and/or received unique identifier and/or associated data (e.g., user, Smartphone number, MAC addresses, location, etc.) from the User's electronic devise/s, for example, smartphone, wearables and/or implantables in the vicinity of the Display. User identifier and/or associated data can be used, for example, for programmatic bidding, generating inventory and/or bid request message to be published on advertising and/or financial exchange/s to serve creatives on the associated Display, tracking, tagging, targeting, cross-device retargeting, conversion, compute advertising metrics and universal attribution with fraud detection and prevention. Provide User/s with methods to interact with the Display via their electronic devices such as smartphones for additional information, redirect to the associated content landing page and to ultimately convert the User.

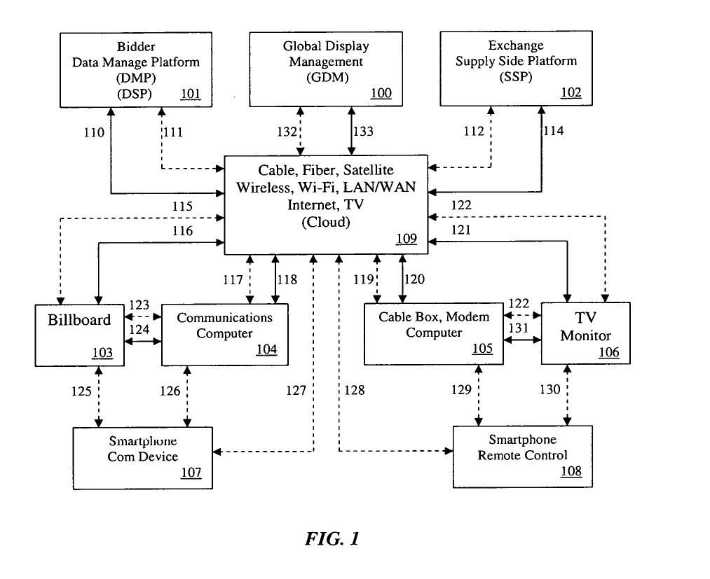

### TECHNICAL FIELD

This invention relates to out of home and home targeted interactive content, infomercial and advertizing. More particularly, to audience, viewer and/or user (referred to as: “User”), User identification (referred to as: “UID”) and/or associated User data, for example, User location (referred to as: “AUD”) to generate inventory or bid request with or without UID/s and/or AUD/s to be posted on advertising exchange/s (referred to as: “Exchange”) for real-time or programmatic bidding (referred to as: “RTB”) to deliver content, infomercials and/or advertisements to the out-of-home and home displays such as electronic or not such as print billboards stationary, for example, attached to buildings, or moving, for example, taxies rooftops, internal and/or external public transportation and/or TV sets/monitors and/or their computers or cable boxes (collectively referred to as: “Displays”) located in the proximity of the User and based on the User profile; and to provide User/s with the ability to interact with the Display and creative to the point of conversion and attribution with detailed metrics and user profile generation.

### BACKGROUND

In out-of-home and home content, infomercial and advertisement, creatives are served to the Display based on its geographic location and time of day without knowing who is viewing the creatives or much less with ability to target, retarget, universal attribution, interaction with content or to convert the User. Furthermore, since creatives for all practical purposes are served statically the inventory is not sold efficiently. Out-of-home and home advertisement is siloed from the rest of ad-tech industry presenting additional inefficiencies to the advertiser.

### SUMMARY

Disclosed herein are systems and methods for out-of-home and home targeted interactive content, infomercial and advertising based on User identification and/or additional information such as AUD for programmatic real-time bidding with or without User interaction comprised of the following methods: for User identification and/or AUD, inventory message generation containing Display ID and/or location, speed and direction of the User, speed and direction of the display, available if any UID/s and/or AUD/s (referred to as: “Inventory”) to be transmitted to for publishing by the designated Exchange/s as Inventory or bid request message (referred to as: “BR”), advertising serving (referred to as: “AS”) and confirmation process (referred to as: “AC”). During the creative display time, User can interact directly with the Display and/or via a their communications device such as a smartphone or TV remote control on the Display and/or their communications device such as a smartphone (referred to as: “UI”) to altimetry convert User with attribution, for retargeting, to generate unified advertizing metrics, generate Users profiles and to consolidate budgets. Additionally, during the same creative display time, User impression message is generated for each User regardless of whether or not eye contact with the Display is detected (referred to as: “Impression”).

The UID is generated by receiving information about User such as: Smartphone number, location, time of travel, start/destination address/s etc. can be generated, for example, by activity dispatcher such as transportation; and/or by identifying the User in the vicinity of the Display by communicating with the User's communication devices or remote control (referred to as: “Device”), for example, smartphone/s, implantable/s, and/or wearable/s via any available communications channels on the Device, for example, NFC, Wi-Fi, Bluetooth, Infrared and/or RFID by obtaining Device's unique identifier, for example, MAC address. Biometrics can also be used to generate UID.

The AUD, for example, is comprised of received and/or retrieved User data such as: Smartphone number, location, time of travel/activity, start/destination address/s, Device's geographic location of the User by using GPS or any other locating or positioning methods such as inertial navigation or telemetry. UID can also be generated utilizing GPS to locate Users in the vicinity of the display. AUD can also contain information describing User behavior in the vicinity of the Display, for example, time spent, User speed, eye contact and/or interaction with the Display.

The Inventory message is generated upon obtaining UID or by an event when User is positioned in the vicinity of the Display. Inventory message containing UID and/or optional AUD and/or User eye contact with the Display message (referred to: “UEC”) along with other data fields, for example, Display ID and Location are transmitted to the Exchange/s via Wi-Fi, TCP/IP, UDP, HTTP/s, Internet, Cable or any other communications protocols or mediums (referred to as: “CM”) for supply side platform (SSP).

Upon receiving Inventory message, Exchange processes it and adds additional fields, generates BR message and transmits it to multiple bidders on the demand side platform (DSP) for bidding.

The AS message is generated upon receiving all bid response messages from DSP, Exchange determines the winner based on the highest bid and transmits win message (referred to as: “Win”) back to the originator of the winning bid response message (referred to as: “Winner”) triggered by original Inventory message over CM along with creative and/or creative id (referred to as: “CID”) in addition to other data fields such as associated link or URL to the creative provider or advertiser landing page and/or call center telephone number (referred to as: “LP”).

The first AC message is generated by the Display upon receiving AS message and the second one at the end of displaying creative. During the creative display time, Impression message/s are generated and sent to the advertisers account. Upon receiving the second AC message, advertiser's account of the winning BR is debited by the bidding amount and informed of the successful transaction and attribution. This process insures reliability and also prevents fraud.

The UI method utilizes all available communications channels between Displays, Devices, Devices' applications, for example, smartphone application (referred to as: “APP”), Exchanges, global display management (referred to as: “GDM”), which may or may not be an integral part of DMP, and/or other sources to obtain, for example, TV programming information such as content, infomercial and/or advertisement to obtain associated LP provided by the advertiser, infomercial and/or content provider and/or Exchange upon receiving first AC message from the Display.

The following are the methods by which Displays and Devices can communicate over, for example, NFC, Bluetooth or Wi-Fi to receive LP to redirect and give the User controls on the Display and/or Device.

The first method, Device/s establishes direct communication channel/s with Display. Upon connecting, Display transmits LP that it received in AS message from Exchange to the Device/s of the currently playing creative and gives the User controls on the Display and/or Device to redirect and navigate LP either on the on the Device or Display or both with or without an APP running on the Device.

The second method, using APP running on the Device, Device establishes direct communication channel with the Display and receives LP that it received in AS message from Exchange and gives the User controls to redirect and navigate LP either on the on the Device or Display or both.

The third method, using APP running on the Device, Device/s establishes direct communication channel with the Exchange or GDS to request and receive LP of associated information displayed on the Display at the time. Upon receiving the LP, the User gets controls to redirect and navigate LP either on the on the Device or Display or both.

The fourth method, using APP running on the Device, Device establishes direct communication channel with the GDS that contains information of locations of all of the Displays, which creative is currently being played, its LP, etc. and transmits its GPS coordinates message (referred to as: “GPSC”). The GDS locates Display in the vicinity of GPSC and transmits the corresponding LP message back the Device. The Device receives LP message and gives the User controls to redirect and navigate LP on the Device itself

1. A computer-implemented method, comprising:
for each individual person from audience, viewers and/or users (“user”) identifying associated electronic devices and/or associated data in the vicinity of out-of-home or home billboards electronic or otherwise, computers, monitors, TVs, and/or displays stationary or moving (“display”) and/or its associated data for real-time and/or programmatic bidding to serve content, infomercial and/or advertisement (“creative”) on the identified display in the vicinity of the user, to provide users with controls to interact with the display to the point of conversion and/or to generate reports, statistics, metrics, user profiles, universal attribution and/or conversion;
generating user identifier based on identifiers of user's out-of-home and/or home electronic devices (“devices”) in the vicinity of the display and/or cross-referencing them to generate universal cross-platform user identifier;
generating user data associated with the user identifier and universal user identifier;
generating display data in the vicinity of the user identifier;
generating inventory message at the display for the exchange based on user identifier, user and associated display data;
generating bid request message for real-time bidding based on received inventory message;
generating win message for the winner of the bid based on received bid response messages;
generating billing and subsequent responses to the win event to display the creative and to confirm and log the display
generating control messages to provide user with methods of interaction with any creative displayed on any type of display electronic or print at any time
generating metrics to track user identifier behavior to generate reports, metrics, frequency capping, universal attribution, user profile based on user detected activities;

2. The method in claim 1, wherein generating user identifier includes retrieving and/or receiving information such as MAC Address/s, Smartphone number, etc. that identifies user electronic device from one or more user's devices:
generating user identifier for each user device; and
generating universal user identifier for all user electronic devices based on user identifier generated for each user device and determining if they belong to the same user by utilizing and correlating user data.

3. The method in claim 2, wherein generating user data associated with each user identifier comprising of all or some additional components:
MAC Address/s; and
Smartphone number;
User travel time; and
Start and destination addresses
determining user geographic location;
determining user moving speed and direction;
determining user display views
determining user time presence duration in the vicinity display; and
determining user eye contact with display.

4. The method in claim 3, wherein generating display data in the vicinity of the user identifier comprising of all or some additional components:
determining display geographic location; and
determining display moving speed and direction.

5. The method in claim 4, wherein generating inventory message/s when User is positioned in the vicinity of the Display includes none, some or all additional components based on user identifier and/or associated user and display data:
user identifier;
MAC Address/s; and
Smartphone number;
User travel time; and
Start and destination addresses
user geographic location;
user moving speed and direction;
user time presence duration in the vicinity display;
user eye contact with display;
display identification number; and
display geographic location; and
display moving speed and direction.

6. The method in claim 5, wherein generating bid request message based on none, some or all additional components of the inventory message and receiving bid response messages from the bidders.

7. The method in claim 6, wherein determining the winning bid and the associated bidder based on the highest bid price and other information received in bid response messages.

8. The method in claim 7, wherein generating billing information and one or more subsequent messages:
generating win message to inform the winner of the bid;
generating creative display message to the associated display with creative identifier and landing page of the creative to be displayed received in the bid request or a separate message; and
generating creative delivery and display message with the creative image to the winning display in the event if creative identifier to be displayed is not cashed on the display;

9. The method in claim 8, wherein generating optional creative display confirmation message at the end of the creative play back to inform the winner.

10. The method in claim 1, wherein providing user with one or more interactive methods by which users, devices, displays and/or global display management (“GDM”) that contains information about displays communicate and interact to receive landing page of the creative/s to redirect the user/s to landing page and to provide user with interactive controls on the display and/or device.

11. The method in claim 10, wherein via user device, user requests direct communication channel with display. Upon connecting, display offers the user to download and install application to interact with any display on the device and/or transmits landing page that it received in creative serve message from GDM or exchange of the currently playing creative on the display and gives the user controls by transmitting and/or receiving control messages over the connection to the display and/or device to redirect and navigate landing page either on the on the device or display or both with or without an application running on the device.

12. The method in claim 10, wherein using application running on the device user establishes direct communication channel with display. Upon connecting, display transmits display id and/or landing page that it received in creative serve message from GDM or exchange to the device of the currently playing creative on the connected display and gives the user controls by transmitting and/or receiving control messages over connection to the display and/or device to redirect and navigate landing page either on the on the device or display or both in application or in browser.

13. The method in claim 10, wherein under user control, application running on the device obtains display id from the display and then establishes direct communication channel with the exchange or GDM and transmits display id with request to receive landing page of associated creative displayed at the time. Upon receiving the landing page, the User gets controls to redirect and navigate landing page either on the on the device or display or both in application or in browser.

14. The method in claim 10, wherein under user control, application running on the device establishes direct communication channel with the exchange or GDM and transmits device GPS location with request to receive landing page of associated creative displayed on the display in the vicinity of the device at the time. Upon receiving the landing page, the User gets controls to redirect and navigate landing page either on the on the device or display or both in application or in browser.

15. The method in claim 10, wherein display is not equipped with a computer and/or communications of any kind, user using application running on the device establishes direct communication channel with the GDM that contains information of locations of all of the displays, which creative currently is being played on the associated display, its landing page, etc., and transmits its GPS location to it. The GDM locates the display in the vicinity of the device and transmits the corresponding landing page back the device of the currently playing creative. The device receives the landing page and gives the user controls to redirect and navigate landing page on the device itself in application or in browser.

16. The method in claim 2, wherein capturing plurality of each individual user identifier activities comprised of one or more user events associated with the display in the vicinity of the user:
display identification and its location
display speed
user location
user speed
timestamp
time duration of the user and display being in the vicinity of one another
user identifier;
user eye contact with the display
user interaction with the display
user selected creative
user conversion
user attribution
user frequency capping

17. The method in claim 16, wherein generating user profile based on plurality of the user activities by characterizing one or more associated events to determine plurality of user characteristics identified by creating tags with or without waited user level of interest for each category of products:
user identifier
user display views
user geographical movements
user shopping trails
user shopping preferences
user shopping patterns
user purchasing index
user eye contact
user interaction with the display index
user conversion index
user demographics

18. The method in claim 16, wherein generating report for each creative displayed with the list of plurality of user activities in the vicinity of the display at that time comprised of one or more events:
walkthrough
display view
click through
conversion

19. The method in claim 18, wherein generating statistics for each user, with all creatives in the vicinity of the user combined, of the occurrence of the events of:
walkthrough
display view
click through
conversion

20. The method in claim 18, wherein generating statistics for each creative, for all users in the vicinity of the creative combined, of the occurrence of the events of:
walkthrough
display view
click through
conversion
